(19) United States
(12) Patent Application Publication
(10) Pub. No.: US 2009/0277823 A1
(43) Pub. Date: Nov. 12, 2009

(54) Refrigeration Device Comprising a Water Filter

(75) Inventors: Martin Buchstab, Bopfingen (DE); Hans Ihle, Giengen (DE); Peter Nalbach, Kirchheim/Nabern (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Haugerate GmbH, Munchen (DE)

(21) Appl. No.: 12/085,937

(22) PCT Filed: Oct. 26, 2006
(86) PCT No.: PCT/EP2006/067808

§ 371 Date: May 28, 2008

(30) Foreign Application Priority Data
Nov. 30, 2005 (DE) 10 2005 057 156.5

(51) Int. Cl. B01D 35/02; B01D 27/00

(52) U.S. Cl. 210/232

(57) ABSTRACT

A refrigeration device comprising an internal water conduit that contains a mounting site for an exchangeable water filter and at least one valve situated downstream of said filter, for controlling the water flow through the conduit. A chemically inert particle filter can be fitted to the mounting site.

The present invention relates to a refrigeration device in which a mounting location for a replaceable water filter is formed in an internal water supply line.

Such a refrigeration device is known from U.S. Pat. No. 6,355,711 B2, for example.

In this known refrigeration device, a switch arrangement that enables a control unit of the device to detect whether or not a filter is present at the mounting location, is provided at said mounting location of the water filter. If a filter is present, the cumulative time period of a water flow through the filter is determined in order to estimate the total amount of water that has flowed through the filter and to output a warning signal for a user if the capacity of the filter is exhausted or nearly exhausted. Instead of the filter it is possible to fit at the mounting location a cover whose sole function is to tightly seal the mounting location, so that no water can escape at that point. The switch arrangement is able to differentiate between the presence of the filter and the presence of the cover and to detect the opening time period of the valve only if a filter is fitted.

A problem of known refrigeration devices with internal water supply line is that valves required to control the water flow in the line can become leaky, so that water escapes in an uncontrolled manner. A known solution to this problem is to provide valve blocks, each having two jointly-activated valves connected in series, so that if one of these valves becomes leaky, the second probably remains leak-proof and thus prevents uncontrolled escape of water. However, this solution is not entirely satisfactory since with such a valve block the user cannot generally ascertain whether one of the valves is leaky, so that if the second one also fails this can cause water to escape, which is just as unexpected and embarrassing for the user as if only one individual valve fails.

The object of the invention is to improve the operational reliability of a refrigeration device in which a mounting location for a replaceable water filter and a valve for controlling the water flow through the supply line are formed in an internal water supply line. The object is achieved in that a chemically inert particle filter can be fitted at the mounting location. In contrast to absorption filters such as active carbon filters, for instance, which filter out from the water chlorine or other substances which have an undesirable odor or taste, and whose limited filter capacity requires their service life to be monitored, as described in U.S. Pat. No. 6,355,177 B2, the service life of a particle filter can easily extend to the service life of the refrigeration device, so that monitoring is unnecessary. A chemically inert particle filter certainly does not improve the taste of the water, but always keeps water-borne solids away from the valve located downstream, so that said solids do not get stuck in the valve and impair its imperviousness.

If necessary, in order to improve the taste of the water as well, the particle filter can preferably be replaced by an absorption filter.

Preferably, the particle filter includes a porous filter element of inert material. Unlike a membrane, the volume of the filter element can collect a large number of particles without seriously impairing the permeability of the filter.

Further features and advantages of the invention are revealed in the description of exemplary embodiments with reference to the accompanying figures, in which:

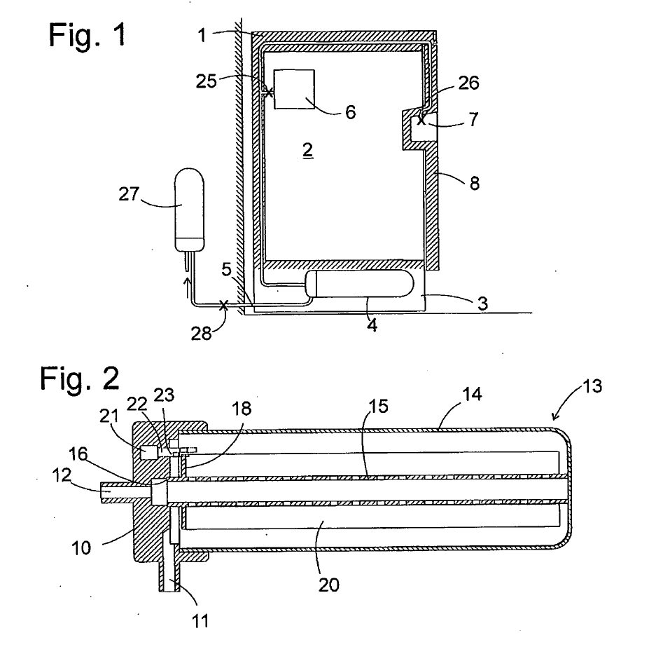

FIG. 1 shows a schematic section through a refrigeration device according to the invention; and

FIG. 2 shows a schematic section through the particle filter of the refrigeration device of FIG. 1.

The refrigeration device shown schematically in FIG. 1 has, in a manner known per se, a body 1 with a heat-insulating internal space 2 and a base area 3 beneath the internal space 2 in which a replaceable water filter 4 is located. The base area 3 contains further components, such as a compressor and a condenser, for instance, which since they are known per se are not illustrated.

The water filter 4 is connected to the domestic water system of a building via a stopcock 28 and a pipe 5 connected to said stopcock, and via a valve 25 supplies an automatic ice maker 6 located in the internal space 2, as well as a dispenser 7 for chilled drinking water that is located in a recess of the door 8. The valve 25 is connected automatically to the supply by an electronic control unit (not shown) if the ice maker 6 signals a demand for water. A valve 26 of the drinking water dispenser 7 can be actuated by placing a receptacle in the recess.

Conventionally, an adsorption filter, in particular an active carbon filter, is used as the water filter 4 to filter out and bind the bothersome flavoring substances in domestic water which contains large amounts of chlorine or for another reason tastes unpleasant.

If the quality of the domestic water is so good that no adsorption filtering is necessary, or if an adsorption filter 27 is already connected in the domestic water system upstream of the refrigeration device, as shown in FIG. 1, a filter of this type is not required in the water supply line 5 of the refrigeration device itself. In such a case, instead of leaving the mounting location of the water filter 4 in the refrigeration device unoccupied, it is proposed to fit a particle filter at this position. This protects the susceptible valves 25, 26 from water-borne particles such as lime, sand or fragments of the filter material of the upstream filter 27. This considerably reduces the risk of the valves 25, 26 becoming leaky due to particles being lodged therein and water escaping in an uncontrolled manner at the ice maker 6 or the dispenser 7. In particular this enables simple valves having a single closeable passage to be provided as the valves 25, 26, whereas conventional dual valves with two closeable passages arranged in series are otherwise employed as protection against leakiness.

FIG. 2 shows a section through the water filter 4 and its retainer in the base area 3 according to a first embodiment. The retainer has a screw or bayonet base 10 with a radially oriented inlet connection 11 and an axially oriented outlet connection 12. A filter cartridge 13 that is screwed or locked into the base 10, has a flask-shaped housing 14 that, adjacent to its open end, is provided with an external thread or bayonet lugs cooperating with the base 10. A tube 15 having multiple perforations, the downstream end 16 of which tightly abuts and encloses the outlet connection 12 at the base 10, extends along the longitudinal axis of the flask.

A hollow cylindrical filter element 20 encloses the tube 15 inside the housing 14. The filter element 20 essentially consists of an inert, finely-porous material such as for instance a ceramic material which allows fine particles carried in the domestic water to penetrate the filter element and there to be deposited over a large volume. A larger quantity of particles can therefore be filtered out and bound than if these are directly deposited onto the surface of the filter element, in which case a smaller quantity of said particles could impair the permeability of the filter.

A switch 21 that can be actuated by a slider 22 is mounted in the base 10. In the configuration shown in FIG. 2, the slider 22 presses against a rib 18 projecting from the tube 15. An adsorption filter likewise mountable in the base instead of the particle filter has a corresponding rib at a different position, so that by means of the status of the switch 21, an electronic controller is able to detect whether a particle filter or an adsorption filter is mounted in the base 10 and monitoring of the quantity of water flowing through the filter and generation of a warning signal if the detected quantity of water exceeds a limiting value, is only implemented if the presence of the adsorption filter is detected. A user who has fitted the particle filter instead of the adsorption filter is therefore not bothered by irrelevant warning signals.

1-6. (canceled)

7. A refrigeration device comprising a mounting assembly for a replaceable water filter formed in an internal water supply line and at least one valve for controlling the water flow through the water supply line disposed downstream of said filter, wherein the mounting assembly is configured for mounting a chemically inert particle filter thereto.

8. The refrigeration device according to claim 7 wherein the mounting assembly is configured for mounting at least one of a particle filter and an adsorption filter.

9. The refrigeration device according to claim 7 wherein the water supply line is configured for directing water to at least one of an ice maker and a cold water dispenser.

10. The refrigeration device according to claim 9 wherein a single valve is disposed between the water filter and at least one of the ice maker and the cold water dispenser.

11. The refrigeration device according to claim 7 wherein the particle filter contains a porous filter element including inert material.
